(19) United States
(12) Patent Application Publication
(10) Pub. No.: US 2002/0001021 A1
(43) Pub. Date: Jan. 3, 2002

(54) Head chip and method of fabricating thereof

(76) Inventor: Masao Tachibana, Chiba-shi (JP)

Correspondence Address: ADAMS & WILKS, 31st Floor, 50 Broadway, New York, NY, 10004, US

(21) Appl. No.: 09/881,995

(22) Filed: Jun. 15, 2001

(30) Foreign Application Priority Data
Jun. 19, 2000 (JP) 2000-183287

(51) Int. Cl. B41J 2/045

(52) U.S. Cl. 347/68

(57) ABSTRACT

A head chip and a head unit reducing fabrication cost and promoting working accuracy are disclosed, A head chip 10 in which partition walls 12 comprising piezoelectric ceramic are arranged at predetermined intervals between two upper and lower sheets of a first and a second board 11 and 16, chambers 13 are partitioned among the respective partition walls 12 and by applying drive voltage to electrodes 14 provided at side faces of the partition walls 12, volumes in the chambers 13 are changed and ink filled at insides thereof is injected from nozzle openings 21 and the first and the second boards 11 and 16 are formed by dielectric material and the partition walls 12 are provided by fixedly attaching piezoelectric ceramic chips at predetermined intervals onto a surface of either of the first and the second boards 11 and 16.

### BACKGROUND OF THE INVENTION

1. Field of the Invention

The present invention relates to a head chip mounted to an ink jet type recording apparatus applied to, for example, a printer or a facsimile and a method of fabricating thereof.

2. Description of the Related Art

Conventionally, there has been known an ink jet type recording apparatus for recording character or image on a recorded medium by using a recording head for injecting ink from a plurality of nozzles. According to the ink jet type recording apparatus, the recording head opposed to the recorded medium is provided at a head holder and the head holder is mounted to a carriage and scanned in a direction orthogonal to a direction of transferring the recorded medium.

FIG. 13 shows a disassembled outline view of an example of such a recording head and FIG. 14A and FIG. 14B illustrate sectional views of essential portions thereof. FIG. 14A is a sectional view of the recording head taken along the longitudinal direction of side walls. FIG. 14B is a sectional view of the recording head taken along the thickness direction of side walls. As shown by FIG. 13 and FIG. 14A,14B, a plurality of grooves 102 are provided at a piezoelectric ceramic plate 101 in parallel with each other and the respective grooves 102 are separated by side walls 103. One end portion in a longitudinal direction of the respective groove 102 is extended up to one end face of the piezoelectric ceramic plate 101 and other end portion thereof is not extended up to other end face thereof and a depth thereof is gradually shallowed. Further, electrodes 105 for applying a driving electric field are formed on surfaces of the two side walls 103 in the respective groove 102 on the side of an opening portion thereof over the longitudinal direction.

A cover plate 107 is bonded to the opening side of the groove 102 of the piezoelectric ceramic plate 101 via an adhering agent 109. The cover plate 107 includes an ink chamber 111 constituting a recess portion communicating with the shallowed other end portions of the respective grooves 102 and an ink supply port 112 penetrated from a bottom portion of the ink chamber 111 in a direction opposed to the groove 102.

Further, a nozzle plate 115 is bonded to an end face of a bonded member bonded with the piezoelectric ceramic plate 101 and the cover plate 107 where the grooves 102 are opened and there are formed nozzle openings 117 at positions of the nozzle plate 115 opposed to the respective grooves 102.

Further, a wiring board 120 is fixedly attached to a face of the piezoelectric ceramic plate 101 on a side opposed to the nozzle plate 115 and on a side opposed to the cover plate 107. At the wiring board 120, there are formed wirings 122 connected to the respective electrodes 105 by bonding wires 121 and drive voltage can be applied to the electrodes 105 via the wirings 122.

According to the recording head constituted in this way, when ink is filled from the ink supply port 112 into the respective grooves 102 and predetermined drive electric field is operated to the side walls 103 of a predetermined one of the grooves 102 via the electrodes 105, the side walls 103 are deformed and volume of the predetermined groove 102 is changed, thereby, ink in the groove 102 is injected from the nozzle opening 117.

For example, as shown by FIG. 15, when ink is injected from the nozzle opening 117 in correspondence with a groove 102a, positive drive voltage is applied to electrodes 105a and 105b at inside of the groove 102a and electrodes 105c and 105d respectively opposed thereto are grounded. Thereby, a drive electric field in a direction directed to the groove 102a is operated to side walls 103a and 103b and when the drive electric field is orthogonal to a polarized direction of the piezoelectric ceramic plate 101, by the piezoelectric thickness slip effect, the side walls 103a and 103b are deformed in directions toward the groove 102a, the volume of the inside of the groove 102a is reduced, pressure is increased and ink is injected from the nozzle opening 117.

However, according to a head chip of recent years, there are desired large size formation and wide width formation accompanied by an increase in a number of the grooves, when the grooves are formed in the piezoelectric ceramic plate, the grooves are formed by grinding the piezoelectric ceramic plate and accordingly, with an increase in the number of the grooves, loss of a piezoelectric ceramic material is increased. Therefore, there poses a problem that the yield is poor and fabrication cost is high.

Further, the grooves are formed by grinding the piezoelectric ceramic plate one by one by a diamond rotary cutter and therefore, there poses a problem that time is taken for grinding, a grinding machine is expensive and cost for depreciation is imposed.

Since the grooves are ground by the diamond rotary cutter, there poses a problem that when grinding is continued, corners of the cutter are rounded by wear, a change in the shape of the groove results, the width of the groove is narrowed and the working accuracy is deteriorated.

### SUMMARY OF THE INVENTION

In view of such a situation, it is a problem of the invention to provide a head chip reducing the fabrication cost and promoting the working accuracy and a method of fabricating thereof.

According to a first aspect of the invention for resolving the above-described problem, there is provided a head chip characterized in a head chip in which partition walls comprising a piezoelectric ceramic are arranged at predetermined intervals between two upper and lower sheets of a first and a second board, chambers are partitioned among the respective partition walls and by applying drive voltage to electrodes provided at side faces of the partition walls, volumes in the chambers are changed and ink filled at insides thereof is injected from nozzle openings wherein the first and the second boards are formed by a dielectric material and the partition walls are provided by fixedly attaching piezoelectric ceramic chips at predetermined intervals to a surface of either of the first and the second boards.

According to a second aspect of the invention, there is provided the head chip according to the first aspect, characterized in that the dielectric material is glass.

According to a third aspect of the invention, there is provided the head chip according to the first or second aspect, characterized in that the piezoelectric ceramic chips are fixedly attached to either of the first and the second boards in a state of being arranged at the predetermined intervals via spacers.

According to a fourth aspect of the invention, there is provided the head chip according to the third aspect, characterized in that the piezoelectric ceramic chips are fixedly attached to either of the first and the second boards and thereafter cut into a predetermined dimension in a longitudinal direction.

According to a fifth aspect of the invention, there is provided the head chip according to the third or fourth aspect, characterized in that the piezoelectric ceramic chips are fixedly attached to either of the first and the second boards and thereafter cut into a predetermined dimension in a thickness direction.

According to a sixth aspect of the invention, there is provided the head chip according to any one of the first through the fifth aspects, characterized in further comprising wirings conductive to the electrodes and extended up to outer sides of end portions of the partition walls in the longitudinal direction at the surface of either of the first and the second boards, wherein the wirings include an inorganic conductive film at a lowermost layer and a metal film formed thereon.

According to a seventh aspect of the invention, there is provided the head chip according to the sixth aspect, characterized in that the electrodes and the metal film are formed by selective electroless plating.

According to an eighth aspect of the invention, there is provided the head chip according to the fifth or the sixth aspect, characterized in that the inorganic conductive film is made of a material of at least one kind selected from a group consisting of ITO, SnO₂, ZnO and ATO.

According to a ninth aspect of the invention, there is provided a method of fabricating a head chip characterized in a method of fabricating a head chip of arranging partition walls comprising piezoelectric ceramic chips at predetermined intervals between two upper and lower sheets of a first and a second substrate, the method comprising a step of fixedly attaching the piezoelectric ceramic chips arranged at the predetermined intervals to the first board via spacers, and a step of removing the spacers and fixedly attaching the second board thereto.

According to a tenth aspect of the invention, there is provided the method of fabricating a head chip according to the ninth aspect, characterized in further comprising a step of cutting the piezoelectric ceramic chips in a predetermined dimension in a longitudinal direction after fixedly attaching the piezoelectric ceramic chips thereto.

According to an eleventh aspect of the invention, there is provided the method of fabricating a head chip according to the ninth or the tenth aspect, characterized in further comprising a step of cutting the piezoelectric ceramic chips in a predetermined dimension in a thickness direction after fixedly attaching the piezoelectric ceramic chips thereto.

According to the invention, the partition walls comprising the piezoelectric ceramic chips are arranged at the predetermined intervals of the board and therefore, loss in working the piezoelectric ceramic material can be minimized. Further, the piezoelectric ceramic chips are preciously formed and therefore, working accuracy of the partition walls and the chambers can be promoted.

### BRIEF DESCRIPTION OF THE DRAWINGS

In the accompanying drawings:

FIG. 1 is a perspective view of a head chip according to an embodiment of the invention;

FIG. 2 is a disassembled perspective view of the head chip according to the embodiment of the invention;

FIG. 3 illustrates a sectional view taken along a direction of providing chambers of the head chip according to the embodiment of the invention in parallel with each other and a sectional view taken along a line A-A′ thereof;

FIG. 4 illustrates top views showing a method of fabricating the head chip according to the embodiment of the invention:

FIG. 5 illustrates sectional views taken along the direction of providing the chambers in parallel with each other in correspondence with respective steps of FIG. 4;

FIG. 6 illustrates top views showing the method of fabricating the head chip according to the embodiment of the invention;

FIG. 7 illustrates sectional views taken along the direction of providing the chambers in parallel with each other in correspondence with respective steps of FIG. 6;

FIG. 8 is a perspective view showing assembling of a unit using the head chip according to the embodiment of the invention;

FIG. 9 illustrates perspective views showing assembling of the unit using the head chip according to the embodiment of the invention;

FIG. 10 illustrates perspective views showing a method of fabricating a head chip according to other embodiment of the invention;

FIG. 11 illustrates perspective views showing the method of fabricating the head chip according to the other embodiment of the invention;

FIG. 12 is a perspective view showing a mode of use of the unit using the head chip according to the embodiment of the invention;

FIG. 13 is a disassembled perspective view showing an outline of a recording head according to a conventional technology;

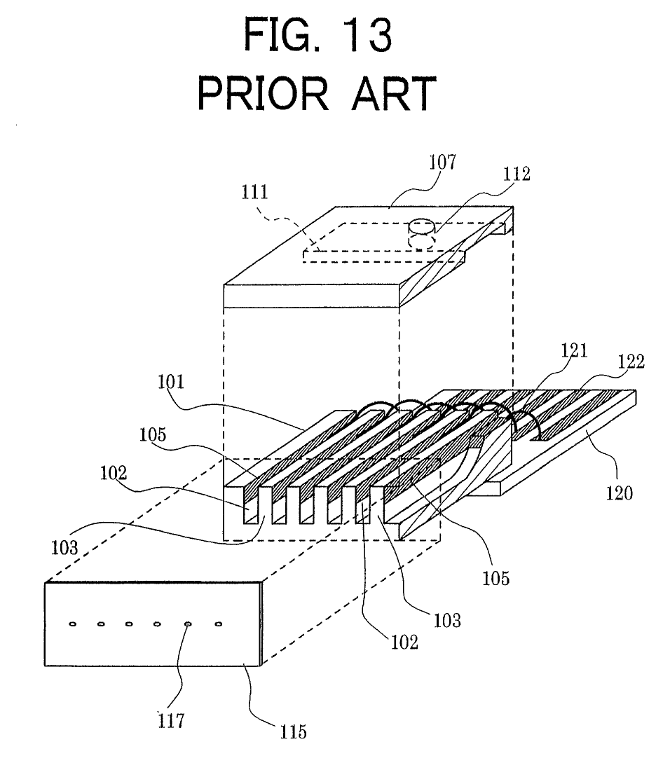

FIG. 14 illustrates sectional views showing the outline of the recording head according to the conventional technology; and

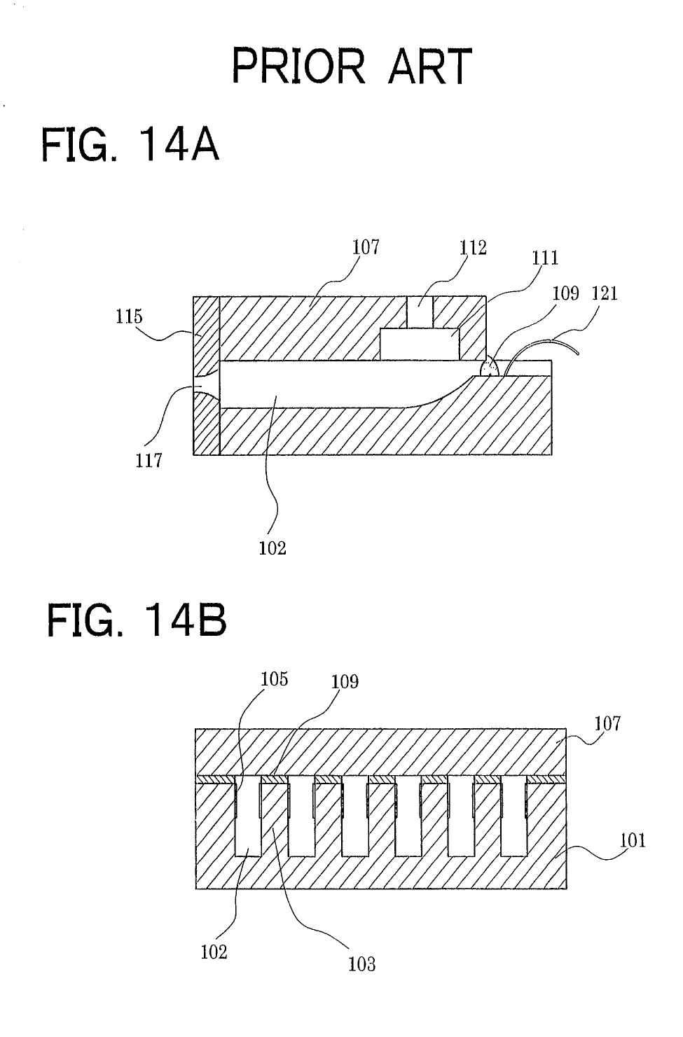

FIG. 15 is a sectional view showing the outline of the recording head according to the conventional technology.

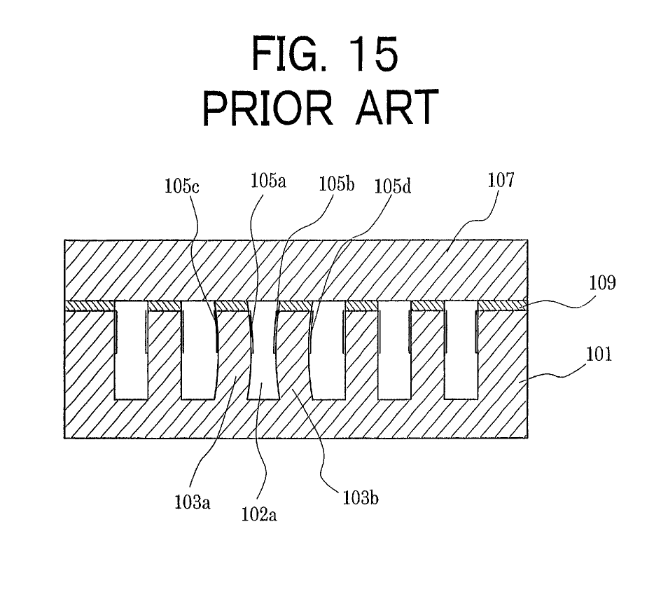

### DETAILED DESCRIPTION OF THE PREFERRED EMBODIMENTS

A detailed explanation will be given of the invention based on embodiments of the invention as follows.

### Embodiment 1

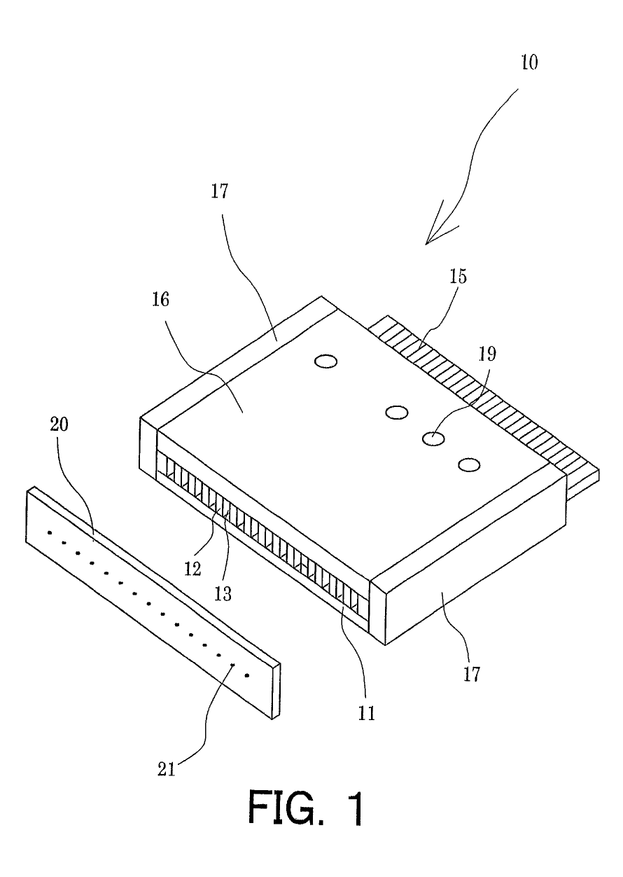

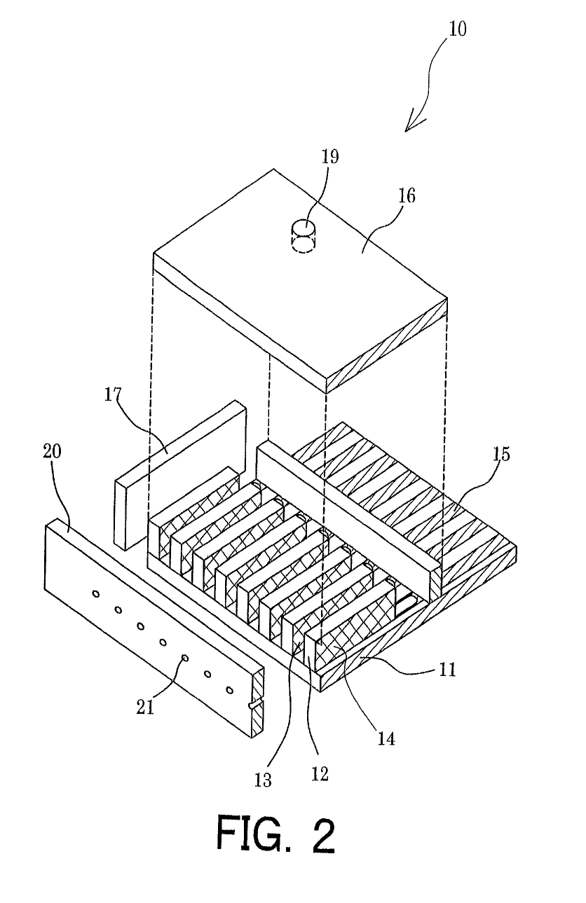

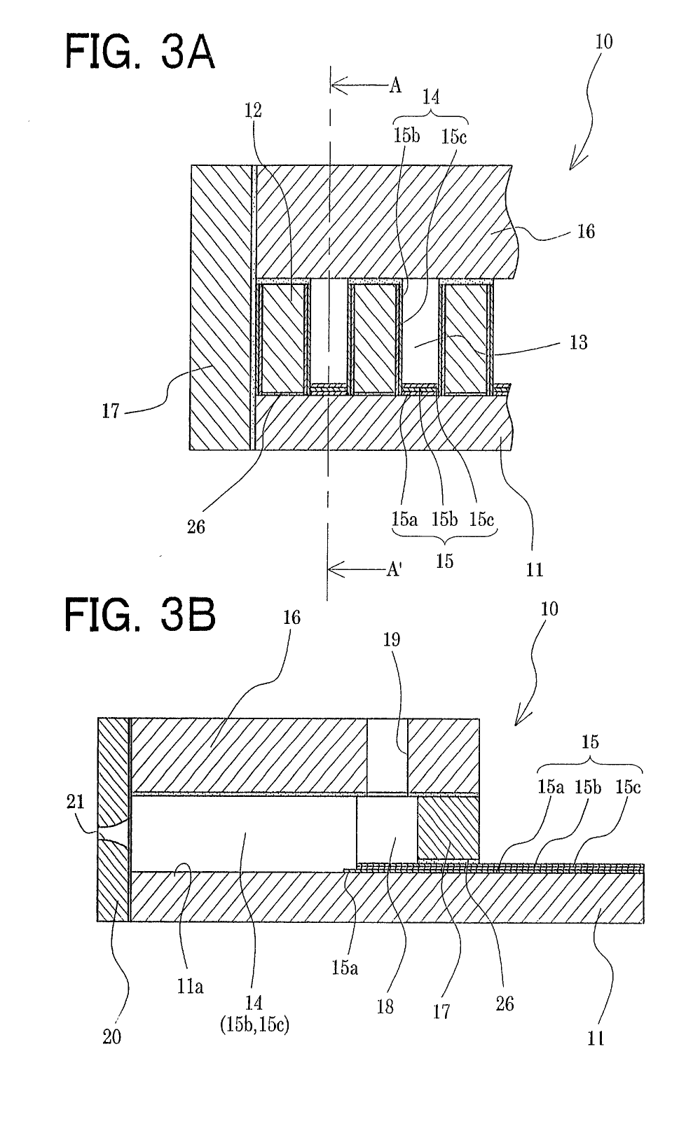

FIG. 1 is a perspective view of a head chip according to Embodiment 1 of the invention, FIG. 2 is a perspective sectional view thereof and FIG. 3 illustrates a sectional view taken along a direction of providing chambers in parallel with each other and a sectional view taken along a line A-A′ thereof.

As illustrated, on top of a flow path board 11 formed by glass in a plate-like shape, there are provided a plurality of chambers 13 partitioned by partition walls 12 by providing a plurality of the partition walls 12 comprising piezoelectric ceramic at predetermined intervals in parallel with each other.

The partition walls 12 are fabricated by forming the piezoelectric ceramic in a predetermined shape and are fixedly attached onto the flow path board 11 via an adhering agent 26.

Further, at a side face of the partition wall 12 constituting an inner face of the respective chamber 13, there is formed an electrode 14 for applying a drive electric field respectively over an entire face thereof.

Further, above the flow path board 11, there is extended a wiring 15 conducted to the respective electrode 14 up to an outer side in a longitudinal direction of the respective partition wall 13.

The wiring 15 is constituted by an inorganic conductive film 15a provided at a lowermost layer and at least one layer of metal films provided above the inorganic conductive film 15a and according to the embodiment, the wiring 15 is constituted by the inorganic conductive film 15a and two layers of metal films 15b and 15c.

In this case, the inorganic conductive film 15a is extended to only one end in the longitudinal direction along with the chamber 13 between the flow path board 11 and the partition wall 12, and is firmly brought into contact with the electrodes 14 at end portions in a width direction of the extended inorganic conductive film 15a, thereby, conduction between the electrode 14 and the wiring 15 is achieved.

Further, although according to the embodiment, the conduction between the wiring 15 and the electrode 14 is achieved by extending the inorganic conductive film 15a between the flow path board 11 and the partition wall 12, the embodiment is not limited thereto so far as the conduction is achieved firmly, for example, the inorganic conductive film 15a may be provided to be brought into contact with an end face of the partition wall 12, further, there may separately be provided a wiring for conducting the electrode 14 and the wiring 15. At any rate, the electrode 14 and the wiring 15 may firmly be conducted.

Further, at a position opposed to one end in the longitudinal direction of the respective partition wall 12 above the flow path wall 11 and at the two side faces of the flow path board 11, there are fixedly attached side walls 17 made of plastic by an adhering agent, there is partitioned an ink chamber 18 communicating with the respective chambers 13 by the guide walls 17 and the flow path board 11 above the glass board 11 and the ink chamber 18 is sealed by a cover plate 16 formed by glass in a plate-like shape bonded to sides of the partition walls 12 opposed to the flow path wall 11. Further, at the cover plate 16, there is formed an ink supply port 19 for supplying ink to the ink chamber 18 by, for example, sandblasting.

Further, a nozzle plate 20 is bonded to end faces of the partition walls 12 flushed with one end face of the flow path board 11 and at positions of the nozzle plate 20 opposed to the respective chambers 13, there are respectively perforated nozzle openings 21. The nozzle plate 20 may be formed by, for example, plastic, glass or polyimide film.

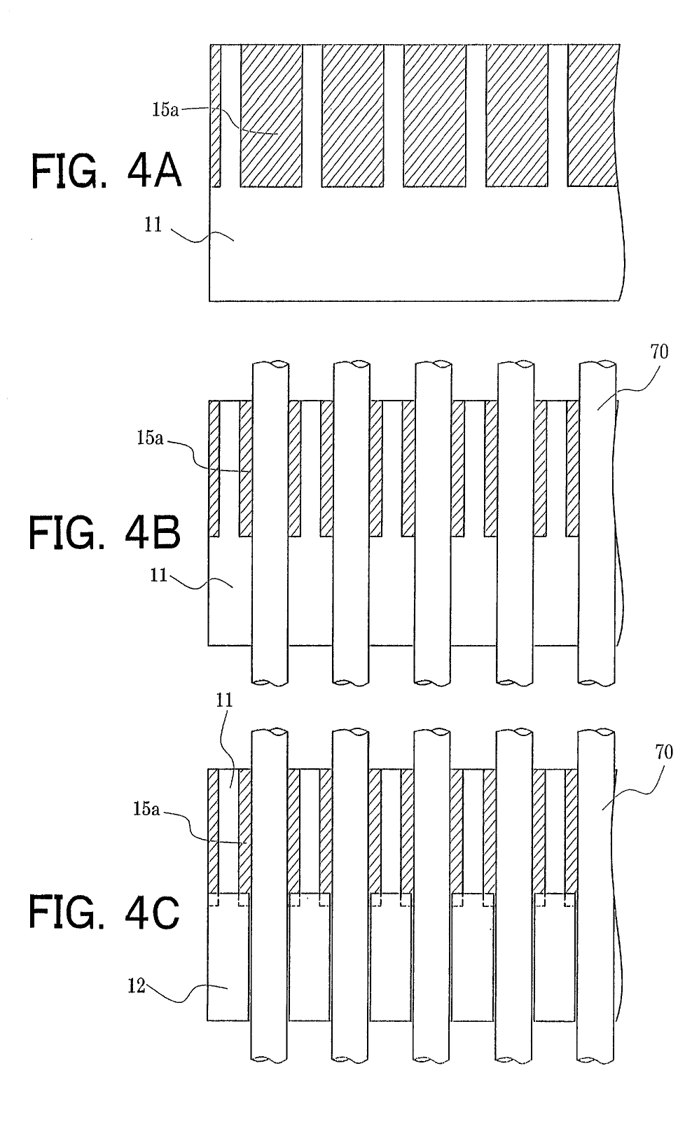

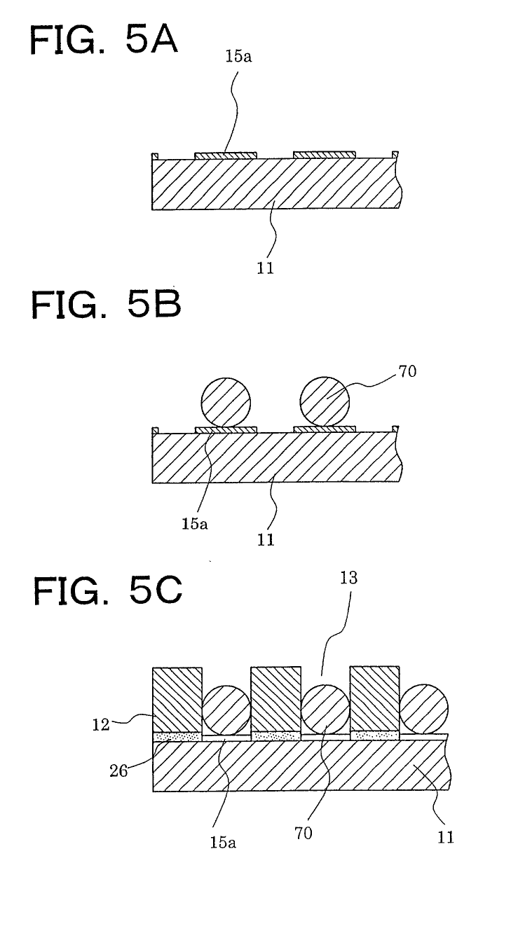

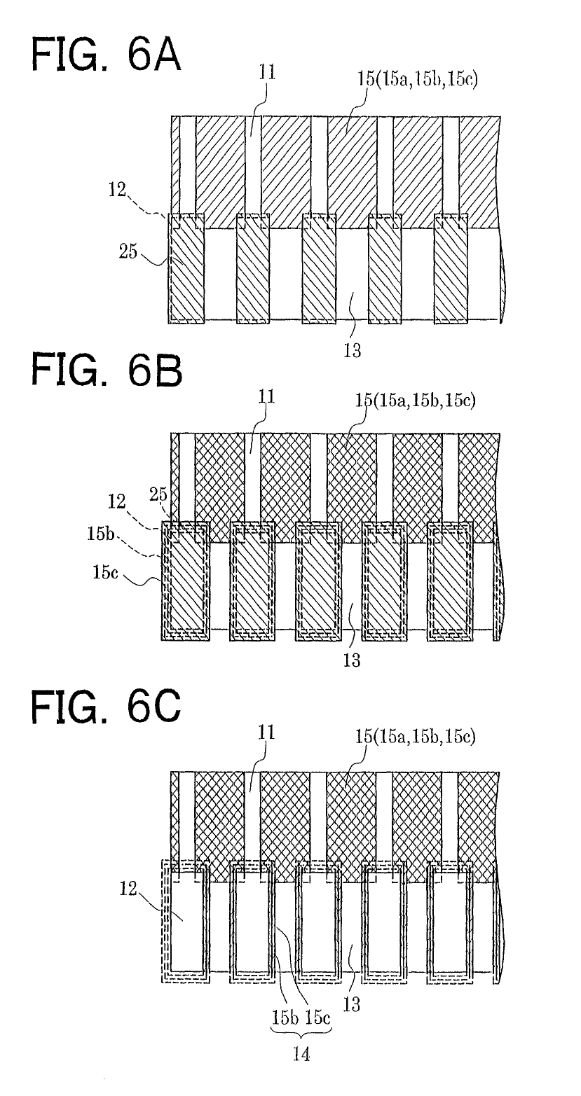

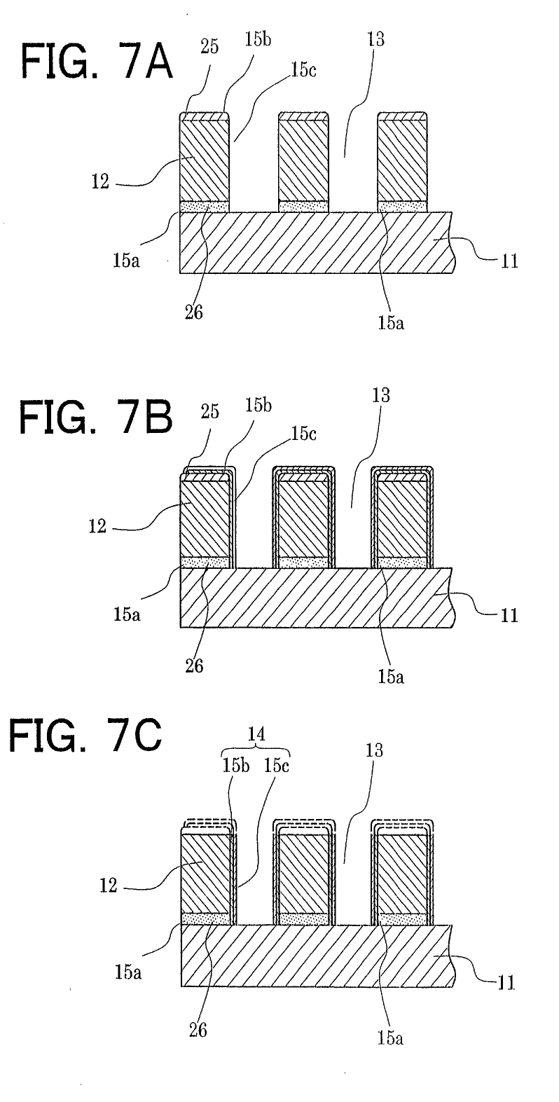

Here, a detailed explanation will be given of steps of fabricating a head chip according to the embodiment. Further, FIG. 4 and FIG. 6 are top views showing steps of fabricating a head chip and FIG. 5 and FIG. 7 are sectional views taken along a direction of providing the chambers 13 in parallel with each other in correspondence with respective steps of FIG. 4 and FIG. 6.

First, as shown by FIG. 4A and FIG. 5A, the inorganic conductive film 15a is formed in a predetermined shape above the flow path board 11 made of glass in the plate-like shape.

In details, after forming the inorganic conductive film 15a above the flow path board 11, the inorganic conductive film 15a is formed, by patterning, on a rear side in a longitudinal direction where the chamber 13 is partitioned above the flow path board 11, with a width more or less larger than the chamber 13 such that a portion of an end portion of the inorganic conductive film 15a is disposed between the flow path board 11 and the partition wall 12.

In this case, as a material of the inorganic conductive film 15a, there is pointed out ITO (oxide of indium and tin), SnO₂, ZnO or ATO (oxide of antimony and tin) and according to the embodiment, ITO is used.

Further, a method of forming the inorganic conductive film 15a is not particularly limited, for example, the film can be formed by a sputtering method or a coating method and thereafter can be patterned by a photolithography method.

Successively, as shown by FIG. 4B and FIG. 5B, there are extended a plurality of guide wires 70 above the flow path board 11 as spacers for prescribing predetermined intervals among the partition walls. The guide wires 70 are used as positioning members when the partition walls 12 are fixed onto the flow path board 11 at later steps and therefore, the respective guide wires 70 are provided in parallel with each other at positions where the chambers 13 are partitioned at intervals more or less wider than the width of the partition wall 12, in this case, at intervals wider than the width of the partition wall 12 by 1 through 2 μm.

Successively, as shown by FIG. 4C and FIG. 5C, the partition walls 12 are fixed onto the flow path board 11 via the adhering agent 26. In details, the partition walls 12 previously coated with the adhering agent 26 at bottom faces thereof are arranged among the guide wires 70 above the flow path board 11 such that the end face of the flow path board 11 and the end faces of the partition walls 12 are flush with each other and the partition walls 12 are fixedly attached onto the flow path board 11 via the adhering agent 26.

Further, the partition wall 12 is a piezoelectric ceramic chip formed by grinding piezoelectric ceramic in a predetermined shape and thereafter polishing thereof and the adhering agent 26 may not be coated at the bottom face of the partition wall 12 but may be coated in a predetermined shape previously to be arranged with the partition wall 12 above the flow path board 11 by screen printing.

Successively, as shown by FIG. 6A and FIG. 7A, a face of the partition wall 12 other than side faces thereof for partitioning the chambers 13, is coated by a resist 25. The step is for removing an extra electrode film at a step, mentioned later. Further, the resist 25 may naturally be provided before adhering the partition wall 12.

Successively, as shown by FIG. 6B and FIG. 7B, at other than the surface of the flow path board 11, that is, over entire faces of the partition walls 12 and the inorganic conductive films 15a, there is adsorbed a start catalyst including palladium or platinum and thereafter, there are successively formed the metal film 15b of nickel and the metal film 15c of gold constituting the electrodes 14 and the wirings 15 by selective electroless plating.

By the selective electroless plating, on outer sides of the partition walls 12, there are formed the wirings 15 comprising three layers of the inorganic conductive film 15a, the metal film 15b of nickel and the metal film 15c of gold and over the entire faces of the partition walls 12, there are formed the metal film 15b of nickel and the metal film 15c of gold. Further, the metal films 15b and 15c provided over the entire faces of the partition walls 12, are conducted to the inorganic conductive films 15a provided between the partition walls 12 and the flow path substrate 11.

Successively, as shown by FIG. 6C and FIG. 7C, by lifting off the resist 25 provided at the top faces of the partition walls 12 and two end faces in the longitudinal direction of the partition walls 12, and unnecessary portions of the metal films 15b and 15c provided on the resist 25, at the side faces of the respective partition walls 12, there are formed the electrodes 14 comprising two layers of the metal film 15b of nickel and the metal film 15c of gold, which are not shortcircuited between two side faces of pairs of the partition walls 12.

As described above, the electrodes 14 formed in this way, are conductive to the wirings via the inorganic conductive film 15a provided between the partition walls 12 and the flow path board 11.

Thereafter, as shown by FIG. 1 through FIG. 3, the guide walls 17 made of plastic are fixedly attached to rear sides of the respective partition walls 12 and two end faces of the glass substrate 11 in the direction of providing the partition walls 12 in parallel with each other by the adhering agent to thereby partition the ink chamber 18 above the flow path board 11. Further, the cover plate 16 is fixedly attached to sides of the partition walls 12 opposed to the glass board 11 by the adhering agent and the nozzle plate 20 perforated with the nozzle openings 21 in correspondence with the respective chambers 13, is fixedly attached to the side end face of the flow path board 11 provided with the partition walls 12 by the adhering agent and the outer configuration is diced to thereby form the head chip 10.

As has been explained, according to the embodiment, the partition walls 12 are provided above the flow path board 11 by fixedly attaching the piezoelectric ceramic chips previously formed in the predetermined shape onto the flow path board 11 by the adhering agent 26 and therefore, loss of the piezoelectric ceramic in forming the partition walls 12 can be minimized. Further, by using much of inexpensive glass at the flow path board 11 and the cover plate 16, fabrication cost can be reduced.

Further, the piezoelectric ceramic chip is formed by previously forming the piezoelectric ceramic in the shape of the partition wall 12 and therefore, the working accuracy of the partition wall 12 can be promoted.

Further, the principle of driving the head chip 10 is as described in the conventional technology and therefore, an explanation thereof will be omitted.

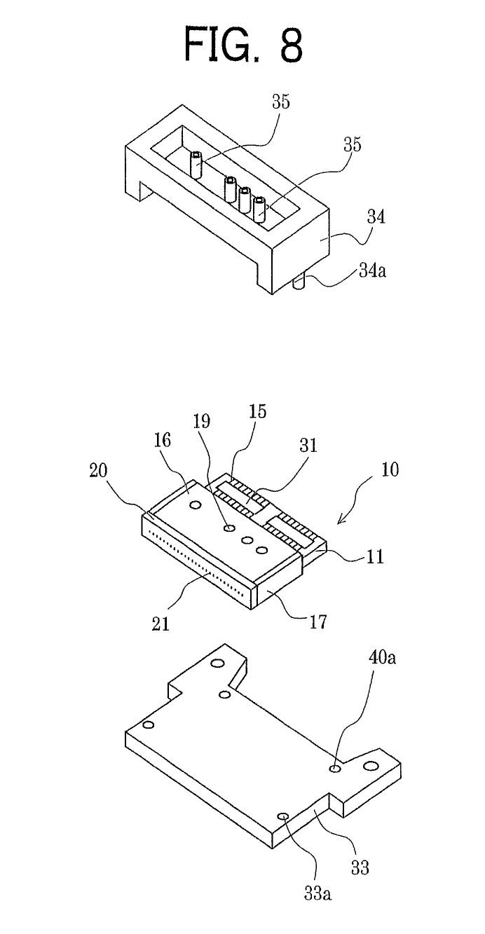

FIG. 8 is a disassembled perspective view of a head chip unit mounted with the head chip 10 described above.

As shown by FIG. 8, above the flow path board 11 of the head chip 10, there is mounted a drive circuit 31 comprising an integrated circuit for driving the head chip 10 by being directly connected to the wirings 15. Further, the head chip 10 is integrated with a base plate 33 made of aluminum on the side of the flow path board 11 and a head cover 34 on the side of the cover plate 16. The base plate 33 and the head cover 34 are fixed to each other by engaging engaging shafts 34a of the head cover 34 to engaging holes 33a of the base plate 33 and the head chip 10 is sandwiched by both members. The head cover 34 is provided with ink introducing paths 35 communicating with respectives of the ink supply ports 19 of the cover plate 16.

Further, the head chip unit 40 is used, for example, by being integrated to a tank holder for attachably and detachably holding an ink cartridge.

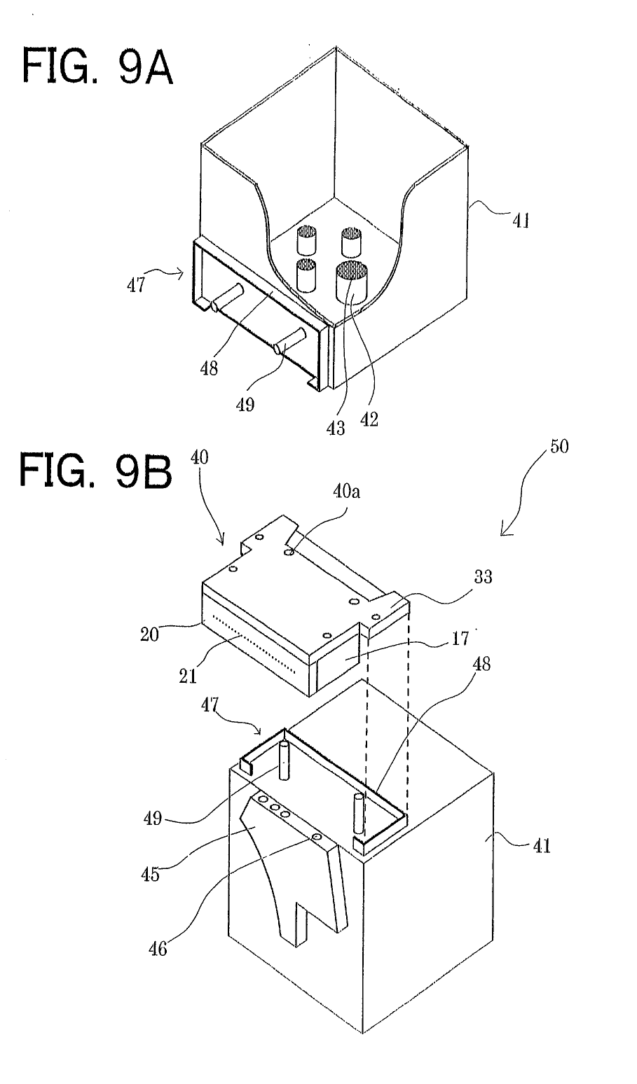

FIG. 9A shows an example of such a tank holder. FIG.9B shows the tank holder 41 and the head chip unit 40 which is assembled with the tank holder 41. The tank holder 41 shown in FIG. 9 is formed substantially in a box-like shape in which one face thereof is opened and is capable of attachably and detachably holding an ink cartridge, not illustrated. Further, at a top face of a bottom wall thereof, there are provided connecting portions 42 connected to the ink supply ports 19 constituting opening portions formed at a bottom portion of the ink cartridge. The connecting portions 42 are provided for respective inks of respective colors of, for example, black (B), yellow (Y), magenta (M) and cyan (C). At inside of the connecting portion 42, there is formed an ink flow path, not illustrated, and a front end of the connecting portion 42 constituting the opening, there is provided a filter 43. Further, the ink flow path formed in the connecting portion 42, is formed to communicate up to a rear face side of the bottom wall and the respective ink flow path communicates with a head connecting port 46 opened at a partition wall of a flow path board 45 via an ink flow path, not illustrated, at inside of the flow path board 45 provided on the rear face side of the tank holder 41. The head connecting port 46 is opened on a side of a side face of the tank holder 41 and at a bottom portion of the partition wall, there is provided a head chip unit holding portion 47 for holding the head chip unit 40, mentioned above. At the head chip unit holding portion 47, there are erected a surrounding wall 48 erected substantially in a channel-like shape surrounding the drive circuit 31 provided above the flow path board 11 and engaging shafts 49 disposed at inside of the surrounding wall 48 for engaging with engaging holes 40 a provided at the base plate 33 of the head chip unit 40.

Therefore, a head unit 50 is completed by mounting the head chip unit 40 to the head chip unit holding portion 47. At this occasion, the ink introducing paths 35 formed at the head cover 34 are connected to the head connecting ports 46 of the ink board 45. Thereby, ink introduced from the ink cartridge via the connecting portion 42 of the tank holder 41, is introduced into the ink introducing path 35 of the head chip unit 40 by passing through an ink flow path at inside of the ink board 45 and is filled in the ink chamber 18 and the chambers 13.

### Other Embodiment

Although an explanation has been given of the head chip according to the invention, the invention is not limited to Embodiment 1, described above.

For example, although according to Embodiment 1, the flow path board 11 is made of glass, the material of the flow path board 11 is not particularly limited so far as the material is a dielectric material.

Further, although according to Embodiment 1, portions of the wirings 15 and the electrodes 14 are constituted by the metal films 15b and 15c produced by the selective electroless plating, the invention is not limited thereto but, for example, with regard to the wirings, a wiring board previously formed with a wiring pattern may fixedly be attached onto the flow path board and with regard to the electrodes, a metal film may be formed by vapor deposition from a skewed direction which is publicly known.

Further, although according to the method of fabricating the head chip 10 of Embodiment 1, the guide wires 70 are provided in parallel with each other as spaces above the flow path board 11 and positioning in fixing the partition walls 12 onto the flow path board 11, is carried out by the guide wires 70, the invention is not limited thereto so far as the partition walls 12 can be arranged at the predetermined intervals above the flow path board 11.

Here, there will be shown other examples of steps of fabricating a head chip.

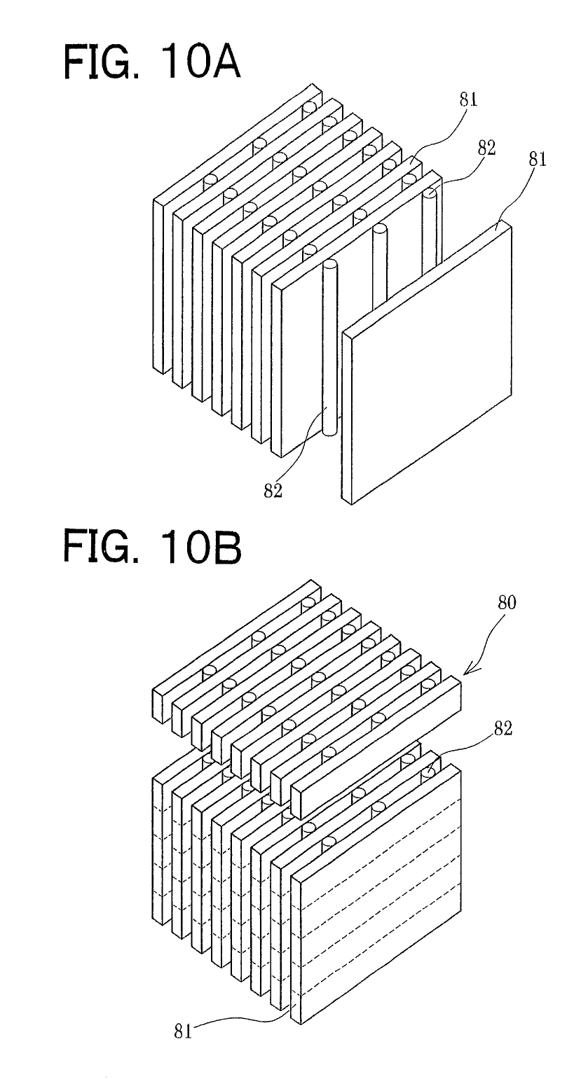

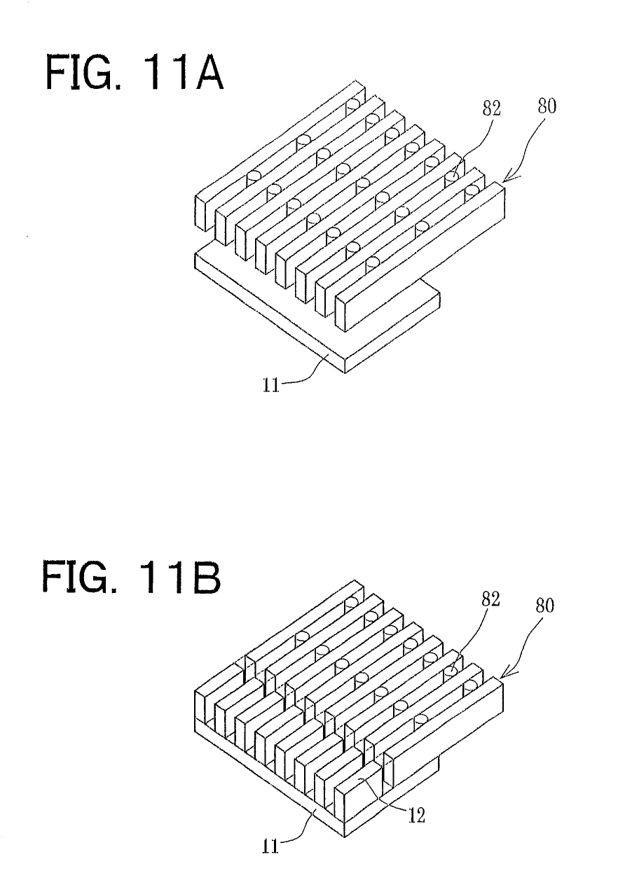

FIG. 10 through FIG. 11 are perspective views showing other steps of fabricating a head chip.

First, similar to Embodiment 1, as shown by FIG. 4A and FIG. 5A, the inorganic conductive film 15a is formed by patterning in a predetermined shape above the flow path board 11.

Successively, as shown by FIG. 10A, on a piezoelectric ceramic plate 81 constituting a material of the partition walls 12, there are provided fixed wires 82 at predetermined intervals in parallel with each other as spacers for prescribing intervals between the partition walls to predetermined intervals and the piezoelectric ceramic plate 81 is further fixed onto the fixed wires 82 to thereby laminate a plurality of the piezoelectric ceramic plates 81 via the fixed wires 82.

Successively, as shown by FIG. 10B, the piezoelectric ceramic plates 81 laminated via the fixed wires 82, are cut to divide by a height of the partition wall 12 in a direction of providing the fixed wires 82 in parallel with each other to thereby form a piezoelectric ceramic plate assembly 80.

Successively, as shown by FIG. 11A, the piezoelectric ceramic plate assembly 80 is fixedly attached onto the flow path board 11 with a cut face of the piezoelectric ceramic plate assembly 80 as an adhering face. At this occasion, the piezoelectric ceramic plate assembly 80 and the flow path board 11 are fixedly attached to each other such that one end face in a longitudinal direction of the piezoelectric ceramic plate 81 and an end face of the flow path board 11 are flush with each other and an adhering agent is coated only at portions of a bottom face of the piezoelectric ceramic plate assembly 80 for constituting the partition walls 12.

Successively, as shown by FIG. 11B, one row of the fixed wires 82 of the piezoelectric ceramic plate assembly 80 above the flow path board 11 in a direction of laminating the fixed wires 82, is eliminated by grinding. At this occasion, portions of the piezoelectric ceramic plates 81 are also ground, the adhering agent is not coated on the portions of the bottom face of the piezoelectric ceramic plate assembly 80 other than those of the partition walls 12 and therefore, only the partition walls 12 are fixedly attached onto the flow path board 11.

Further, the length of the chamber 13 is the interval for providing the fixed wires 82 in parallel with each other and therefore, it is necessary to provide the fixed wires 82 in parallel with each other previously at pertinent intervals.

Thereafter, similar to the fabricating steps shown in FIG. 6 through FIG. 7 of Embodiment 1, mentioned above, the electrodes 14 and the wirings 15 are formed at the flow path board 11 provided with the partition walls 12, the guide walls 16, the cover plate 17 and the nozzle plate 20 are fixedly attached and the outer configuration is ground to thereby form the head chip 10.

According to the fabricating steps, loss of the piezoelectric ceramic can be restrained and the head chip can be fabricated at lowcost. Further, shortening of a fabricating time period can be achieved.

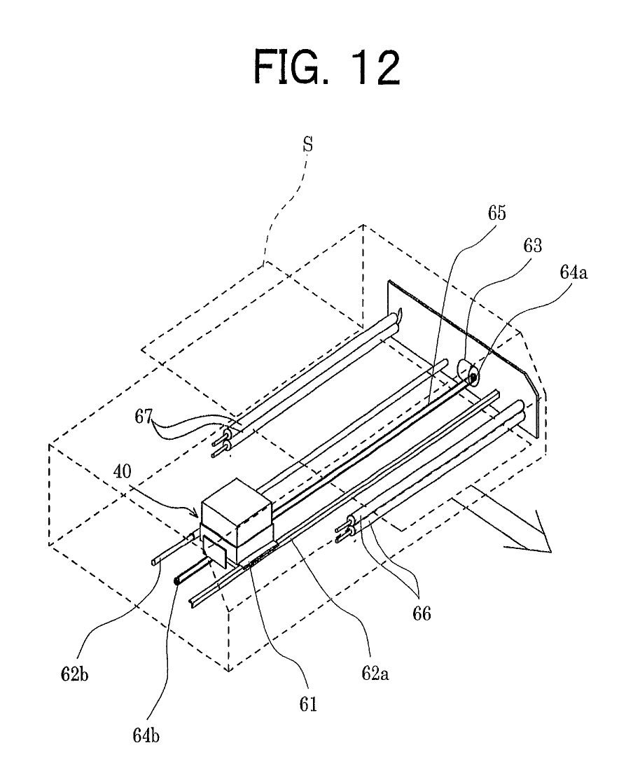

Further, the above-described head unit 50 is used by, for example, being mounted to a carriage of an ink jet type recording apparatus. FIG. 12 shows an outline of an example of the mode of use.

As shown by FIG. 12, a carriage 61 is mounted over a pair of guide rails 62a and 62b movably in the axial direction and is carried via a timing belt 65 hung over a pulley 64a connected to a carriage drive motor 63 provided at ends of the guide rails 62 on one side and a pulley 64b provided at ends thereof on other side. There are provided respective pairs of carry rollers 66 and 67 along the guide rails 62a and 62b on both sides of the carriage 61 in a direction orthogonal to a direction of carrying the carriage 61. The carry rollers 66 and 67 carry a recorded medium S on a lower side of the carriage 61 in the direction orthogonal to the direction of carrying the carriage 61.

The above-described head unit 50 is mounted above the carriage 61 and the above-described ink cartridge can be attached attachably and detachably to the head unit 50.

According to the ink jet type recording apparatus, character and image can be recorded on the recorded medium S by the head chip by scanning the carriage 61 in the direction orthogonal to a direction of feeding the recorded medium S while feeding thereof.

As has been explained above, according to the invention, the upper and lower boards are formed by a dielectric material, the piezoelectric ceramic chips previously formed in the predetermined shape, are fixedly attached onto the board via the spacers to thereby form the partition walls and accordingly, loss of the piezoelectric ceramic in forming the partition walls can be minimized, the fabrication cost can be reduced and the fabrication time period can be shortened. Further, the chambers are not formed by grinding but the partition walls and the chambers are partitioned by providing the piezoelectric ceramic chips on the board via the spacers and therefore, accuracy of the partition wall and the chamber can be promoted.

What is claimed is:

1. A head chip characterized in a head chip in which partition walls comprising a piezoelectric ceramic are arranged at predetermined intervals between two upper and lower sheets of a first and a second board, chambers are partitioned among the respective partition walls and by applying drive voltage to electrodes provided at side faces of the partition walls, volumes in the chambers are changed and ink filled at insides thereof is injected from nozzle openings:
wherein the first and the second boards are formed by a dielectric material and the partition walls are provided by fixedly attaching piezoelectric ceramic chips at predetermined intervals to a surface of either of the first and the second boards.

2. The head chip according to claim 1, characterized in that the dielectric material is glass.

3. The head chip according to claim 1, characterized in that the piezoelectric ceramic chips are fixedly attached to either of the first and the second boards in a state of being arranged at the predetermined intervals via spacers.

4. The head chip according to claim 3, characterized in that the piezoelectric ceramic chips are fixedly attached to either of the first and the second boards and thereafter cut into a predetermined dimension in a longitudinal direction.

5. The head chip according to claim 3, characterized in that the piezoelectric ceramic chips are fixedly attached to either of the first and the second boards and thereafter cut into a predetermined dimension in a thickness direction.

6. The head chip according to claim 1, characterized in further comprising wirings conductive to the electrodes and extended up to outer sides of end portions of the partition walls in the longitudinal direction at the surface of either of the first and the second boards, wherein the wirings include an inorganic conductive film at a lowermost layer and a metal film formed thereon.

7. The head chip according to claim 6, characterized in that the electrodes and the metal film are formed by selective electroless plating.

8. The head chip according to claim 6, characterized in that the inorganic conductive film is made of a material of at least one kind selected from a group consisting of ITO, SnO₂, ZnO and ATO.

9. A method of fabricating a head chip characterized in a method of fabricating a head chip of arranging partition walls comprising piezoelectric ceramic chips at predetermined intervals between two upper and lower sheets of a first and a second substrate, said method comprising:
a step of fixedly attaching the piezoelectric ceramic chips arranged at the predetermined intervals to the first board via spacers; and
a step of removing the spacers and fixedly attaching the second board thereto.

10. The method of fabricating a head chip according to claim 9, characterized in further comprising a step of cutting the piezoelectric ceramic chips in a predetermined dimension in a longitudinal direction after fixedly attaching the piezoelectric ceramic chips thereto.

11. The method of fabricating a head chip according to claim 9, characterized in further comprising a step of cutting the piezoelectric ceramic chips in a predetermined dimension in a thickness direction after fixedly attaching the piezoelectric ceramic chips thereto.
